(19) United States
(12) Patent Application Publication
(10) Pub. No.: US 2012/0124291 A1
(43) Pub. Date: May 17, 2012

(54) Secondary Cache Memory With A Counter For Determining Whether to Replace Cached Data

(75) Inventors: Heather D. Achilles, Hudson, NH (US); Timothy Hume Heil, Rochester, MN (US); Anil Krishna, Cary, NC (US); Nicholas David Lindberg, Rochester, MN (US); Steven Paul VanderWiel, Rosemount, MN (US); Shaul Yifrach, Haifa (IL)

(73) Assignee: International Business Machines Corporation, Armonk, NY (US)

(21) Appl. No.: 12/946,883

(22) Filed: Nov. 16, 2010

(51) Int. Cl. G06F 12/08

(52) U.S. Cl. 711/122; 711/E12.017

(57) ABSTRACT

A selective cache includes a set configured to receive data evicted from a number of primary sets of a primary cache. The selective cache also includes a counter associated with the set. The counter is configured to indicate a frequency of access to data within the set. A decision whether to replace data in the set with data from one of the primary sets is based on a value of the counter.

### BACKGROUND

Aspects of the present invention relate in general to cache systems, and more particularly, to methods and systems for increasing the performance of cache systems which include a secondary cache used to hold data evicted from a primary cache.

Modern computer processors operate by fetching data from a memory system and performing operations on that data. This fetching process typically occurs at a slower rate than the processor is capable of operating. To reduce the amount of time spent fetching instructions and data from the memory system, a processor system typically uses a cache. A cache is a faster performance memory system that temporarily stores recently used data.

A cache is typically much smaller than the main memory for which it temporarily stores data. Thus, multiple sections of the main memory array are mapped to one section in the cache. These sections are often referred to as blocks. When data from within a block in main memory is accessed by the processor, that entire block of data will then be placed into a corresponding block in the cache that maps to that block in main memory. If another block in main memory maps to that same cache block, and the processor accesses data within that main memory block, then the old block of data in the cache is evicted and the newly accessed block of data from the main memory is placed in the cache.

When a processor attempts to fetch data from memory, it first checks the cache. If the desired data is found in the cache, then the processor can fetch the data from the cache instead of the main memory. This is referred to as a cache hit. When the desired data is not in the cache, the result is referred to as a miss.

### BRIEF SUMMARY

A selective cache includes a set configured to receive data evicted from a number of primary sets from a primary cache, and a counter associated with the set, the counter configured to indicate a frequency of access for data within the set. A decision whether to replace data in the set with data from one of the primary sets is based on a value of the counter.

A cache system includes a primary cache including a number of primary sets and a secondary cache including a number of secondary sets. Each of the secondary sets is configured to receive data evicted from a number of the primary sets, increment a counter associated with that set in response to a hit to that set, decrement the counter in response to eviction of data from one of the number of the primary sets when the counter has a non-zero value, and replace data within the secondary set with the data from the number of the primary sets if the counter is at zero.

A method for managing data evicted from a primary cache system includes storing data evicted from a number of primary sets from the primary cache system in a secondary set of a secondary cache system, using a counter to indicate a frequency of access of data within the secondary set; and deciding whether to replace data in the secondary set with data evicted from one of the primary sets based on a value of the counter.

A method for managing data evicted from a primary cache system includes storing data evicted from a number of primary sets from the primary cache system in a secondary set of a secondary cache system, incrementing the counter in response to a hit to the secondary set, decrementing the counter in response to eviction of the data from the one of the primary sets when the counter has a non-zero value, and replacing the data within the secondary set with the data from one of the primary sets if the counter is at zero.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative processing system, according to one example of principles described herein.

FIG. 2 is a diagram showing an illustrative association of sets between a primary cache and a secondary cache system, according to one example of principles described herein.

FIGS. 3A and 3B are flowcharts showing an illustrative method of using a counter to indicate a frequency of access for a particular set of data within a secondary cache, according to one example of principles described herein.

FIG. 4 is a diagram showing an illustrative timeline of data placement within a cache system using a counter, according to one example of principles described herein.

FIG. 5 is a flowchart showing an illustrative method for managing data evicted from a primary cache system, according to one example of principles described herein.

Throughout the drawings, identical reference numbers designate similar, but not necessarily identical, elements.

### DETAILED DESCRIPTION

In some cases, a secondary cache system is used to store data evicted from the main or primary cache in case that data is needed again by the processor. This type of secondary cache may be referred to as a victim cache. A victim cache would usually be smaller than the primary cache system. Thus, several sections within the primary cache will be mapped to one section within the victim cache. In some cases, the several sections in the primary cache will utilize a particular section of the secondary cache at different rates. This imbalance can reduce the overall performance of a processing system using the victim cache.

The present specification discloses method and system for managing a cache system. Particularly, this specification discloses a secondary cache that is capable of achieving higher performance in the event that a set within the secondary cache experiences an imbalanced reception of evicted data from the different sets within the primary cache associated with that set within the secondary cache.

Throughout this specification and in the appended claims, the term “primary cache” is to be broadly interpreted as a cache that places evicted data into a “secondary cache.”

A “set” is to be broadly interpreted as a portion or section of a memory device, either a main memory or a cache. A portion or set of a first memory array that may be mapped to a corresponding portion or section of a second memory array. For example, a set within a main memory may be mapped to a set in a primary cache. Additionally, a set within a primary cache may map to a set within a secondary cache. A set may include a number of blocks of data. Sets within a primary cache will be referred to as primary sets, and sets within a secondary cache will be referred to as secondary sets.

According to certain illustrative examples, a number of primary sets are associated with a particular secondary set. Each secondary set includes a counter. This counter is used to indicate how often the data within that secondary set is accessed by the computing system. This may be done, for example, by incrementing the counter each time there is a hit to the secondary set.

When data is evicted from one of the primary sets, the system then checks the counter to see if it is worthwhile to replace the current data in the secondary set with the evicted data from the primary set. For example, if the counter is non-zero, this means that the data in that secondary set has been accessed and is thus still possibly of use. In this case, it may not be most efficient to replace that data. The counter is then decremented, indicating that there is a demand for other data to use that particular secondary set. If data is evicted from a primary set, and the counter for the associated set is at zero, then the evicted data can replace whatever data is currently in the secondary set.

Through use of a system or method embodying principles described herein, a secondary cache is better able to utilize data evicted from a primary cache. Particularly, data that has been evicted from the primary cache, and is still more likely to be accessed by the computing system, will be more likely to stay in the secondary cache. This reduces the number of times the system must fetch data from a slower memory system, thus speeding up the performance of the overall system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

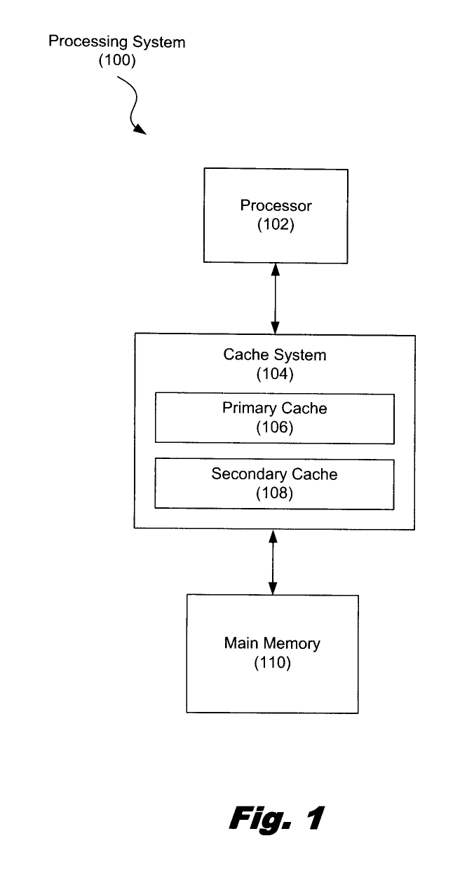

With reference now to the figures, FIG. 1 is a diagram showing an illustrative processing system (100). According to certain illustrative examples, the processor system (100) includes a processor (102), a cache system (104) that includes a primary cache (106) and a secondary cache (108), and a main memory (110).

The processor (102) of a computing device performs the various mathematical and logical functions that make up the basis of computer processing. The processor (102) operates by fetching a set of instructions that make up a program. These instructions are typically stored in some memory system such as a main memory (110). As mentioned above, the process of retrieving instructions and other data for processing by the processor takes a relatively large amount of time. This wastes time as, in general, processors are capable of operating at much higher speeds than most memory systems.

As mentioned above, cache systems (104) are typically used to bridge the performance gap between a processor (102) and main memory (110). The processor typically fetches data from main memory in a set of bits referred to as a word. A word may be 16 bits, 32 bits, or 64 bits depending on the system architecture. When a processor fetches a word from main memory, the cache system (104) is first checked to see whether or not the desired word resides in the cache. If the target word is indeed in the cache (104), then the target word does not need to be fetched from main memory. This is referred to as a hit. Cache systems (104) are designed to operate faster than the rates at which main memory systems typically operate. Thus, the time it takes to retrieve the target word from the cache (104) is significantly less than the time it takes to retrieve the same target word from main memory.

If the target word is not in the cache (104), then it must be fetched from main memory. This is referred to as a miss. Additionally, the block of data from the main memory (110) where the target word is located is then moved into the cache system. In some cases, when a block of data is moved from memory (110) into the cache (104), it replaces an older block of data belonging to one of the other sets in main memory (110) associated with that set in the cache (104). The older block of data is then evicted from the cache (104).

The system of using a secondary cache and a primary cache may be done in many ways. For example, some processor caches include a victim cache used specifically for data evicted from the main processor cache. Some processor caches include a Level 1 (L1) cache and a Level 2 (L2) cache. In this case, the L2 cache may be configured to hold data evicted from the L1 cache. In general, a primary cache may be a cache system that is close to the processor and a secondary cache may be a cache system that is farther away from the processor.

Cache systems may be used for other purposes besides transferring data between a processor and a memory. For example, a cache may be used to bridge the performance gap between a local non-volatile storage device such as a hard drive and a remote storage location such as an internet server. Although the examples described herein relate to a processor cache, the principles described herein may apply to other types of cache systems as well.

Many computer programs will need to access the same set of instructions several times throughout the execution of the program. In some cases, these different instructions are located in different sets within main memory (110). These different sets may also map to the same set within the cache (104). In this case, the instructions from two or more different sets in the main memory (110) will continually be evicting each other from the cache system, causing a number of misses in the cache. These types of misses are referred to as conflict misses.

The process of continual cache misses due to a number of sets in main memory competing for the same spot in the cache is referred to as thrashing. The problem of thrashing can sometimes be reduced through use of dividing the cache into a primary cache (106) and a secondary cache (108).

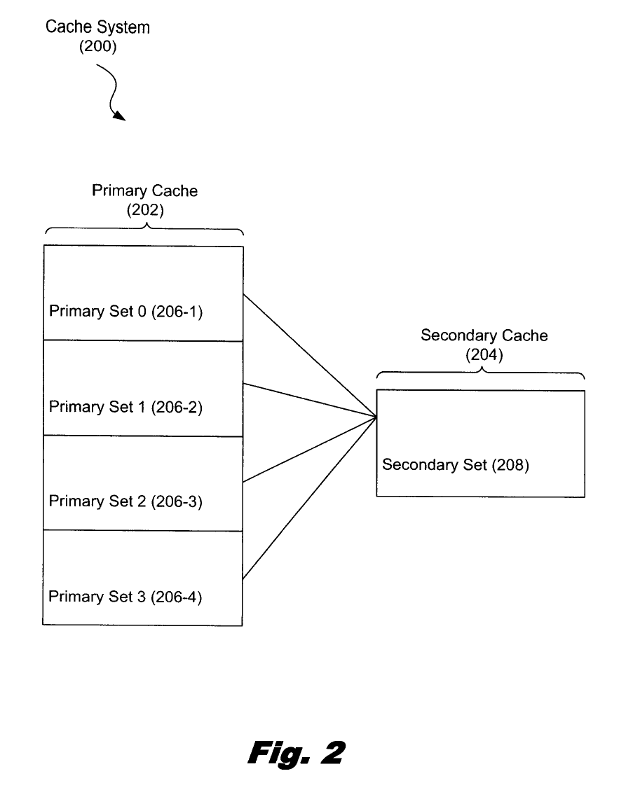

FIG. 2 is a diagram showing an illustrative association of sets between a primary cache (202) and a secondary cache (204). As indicated above, a block of data includes a predefined number of words. When a system retrieves a word from main memory, the entire block of data where the word is located is moved into the cache rather than just the word itself. This is to take advantage of the fact that many programs exhibit both spatial and temporal locality. Spatial locality refers to the fact that subsequently accessed instructions are often placed in close proximity to each other within a memory array. Temporal locality refers to the fact that a particular instruction is likely to be accessed again as part of a loop.

When a set in a cache system corresponds to only one block of data, the cache system is referred to as a direct mapped cache. If a set includes more than one block of data, the cache is referred to as an associative cache. Particularly, if a cache system includes 2 blocks per set, then that cache system is referred to as a 2-way associative cache. Direct mapped caches are generally simpler in operation. Thus, for purposes of illustration, the examples described herein will use a direct mapped cache. However, the same principles will apply to associative cache systems as well.

FIG. 2 illustrates a cache system (200) that includes a primary cache (202) that includes four primary sets (206) numbered 0-3. Additionally, the cache system includes a secondary cache (204) with a secondary set (208). The secondary set (208) maps to each of the primary sets (206) illustrated. The cache system (200) illustrated in FIG. 2 is a simplified version of a practical cache system. A practical cache system may include several sets within the secondary cache, each secondary set mapping to a different group of primary sets.

If a block of data is evicted from one of the primary sets (206), then that block of data is placed in the secondary set (208). In one example, a first block of data from main memory is placed into primary set 1 (206-2). Then, a second block of data is accessed by the processor which also maps to primary set 1. In this case, the first block of data would be evicted from primary set 1 (206-2) and placed into the secondary set (208). The second block of data would then be placed into primary set 1 (206-1). It is very common for programs to continually access two different blocks of data during execution. For example, the system may continually alternate access between the first block of data and the second block of data placed in both primary set 1 (206-2) and the secondary set (208). In this case, the secondary cache (204) provides additional associativity to primary set 1 (206-2).

The additional associativity provided by the secondary cache (204) is flexible. This means that the additional associativity can be provided to any of the primary sets. In some cases this flexibility can degrade performance. For example, while a system may alternate between the first and second block of data, it may also access other blocks of data in the other sets. In one example, the processor accesses a third block of data which is placed in primary set 2 (206-3). The system then accesses a fourth block of data which causes the third block of data to be evicted from primary set 2 (206-3). This causes the third block of data to be placed in the secondary set (208), evicting the second block of data from the secondary set (208). The next time the system needs to access the second block of data, the cache system (200) will miss, requiring the second block of data to be retrieved again from main memory.

If the secondary set (208) receives a balanced use between all of the primary sets (206) mapped to that secondary set, then the issue described above is expected. However, it is often the case that one particular primary set (206) will use the secondary set (208) more than the other primary sets (206) mapped to that same secondary set (208). In light of this issue, the present specification discloses a method of using a counter to indicate the usefulness of data stored in a particular secondary set. As used herein the “usefulness” of data refers to the frequency with which that data is needed and accessed by the processor.

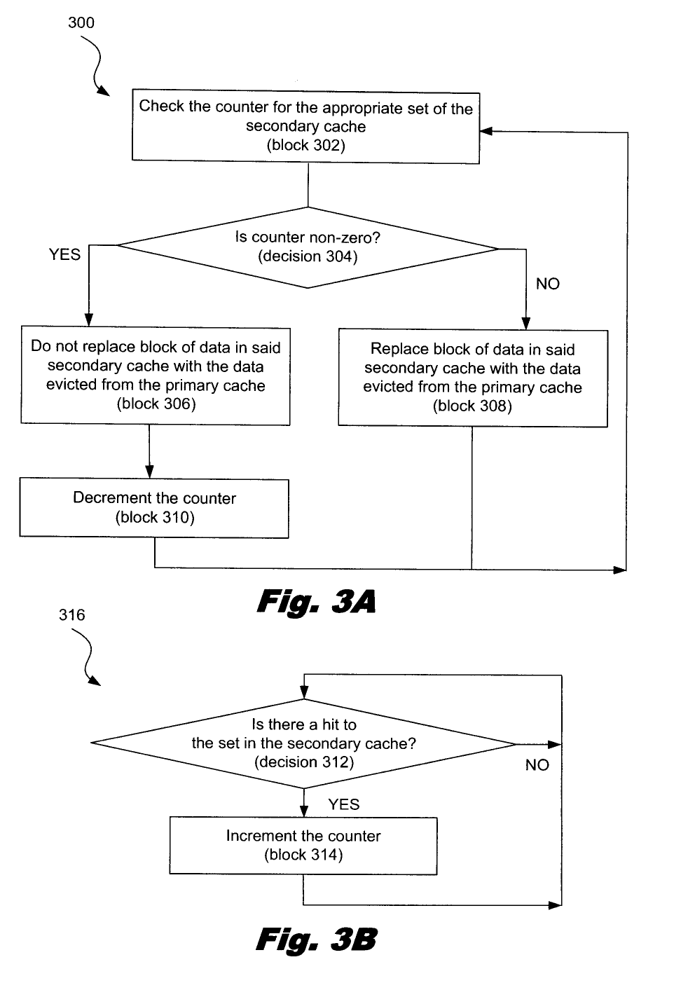

FIGS. 3A and 3B are flowcharts showing an illustrative method of using a counter to indicate a frequency of access for a particular set of data within a secondary cache. FIG. 3A illustrates a method (300) for writing data to a secondary cache. According to certain illustrative examples, a block of data from main memory may be placed in a particular set in the primary cache. This will cause the previous block of data to be evicted from the primary cache.

The method (300) starts by checking (block 302) the counter associated with the secondary set where the block of data is to be placed. The method then determines (decision 304) whether or not the counter has a non-zero value. If the counter does indeed (decision 304, YES) have a non-zero value, then the block of data in the secondary set is not replaced (block 306) with the block of data evicted from the primary cache. Additionally, the counter is then decremented (block 310). If the counter has a value of zero (decision 304, NO), then the block of data in the secondary set is replaced (block 308) with the block of data evicted from the primary cache.

FIG. 3B is a flowchart showing an illustrative method (316) for reading data within the secondary cache. During normal processing operations, the processor may request data that is stored in memory. The system will then check to see if the desired data is in primary cache. If desired data is not in the primary cache, then the system will check to see if the desired data is in the secondary cache. The system will then determine (decision 312) whether or not there is a hit to the secondary cache. If there is indeed (decision 312, YES) a hit to the secondary cache, then the counter is incremented (block 314). If there is not (decision 312, NO) a hit to the secondary cache, then nothing will happen until there either is a hit to the secondary cache or until a new block of data assigned to the secondary set is evicted from the primary cache.

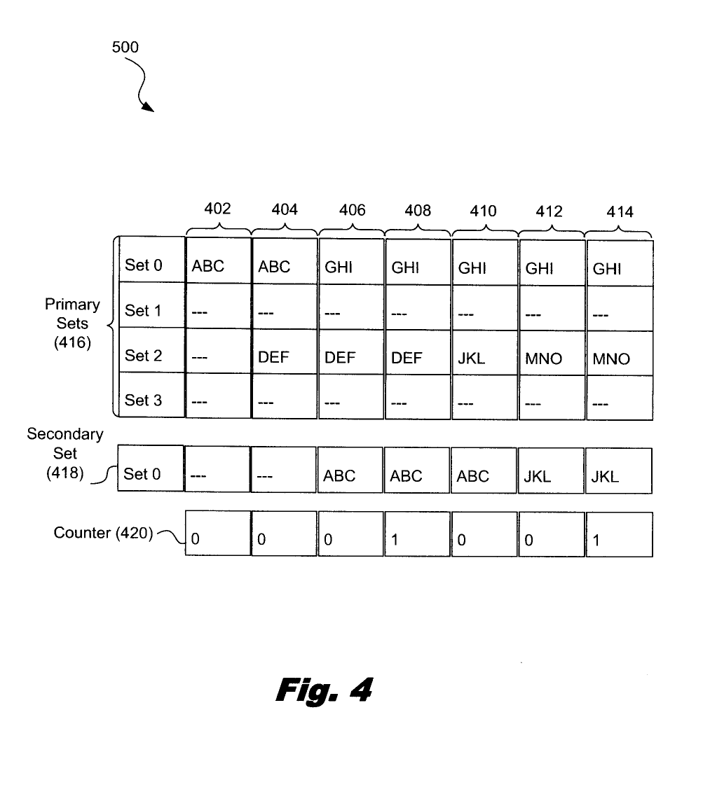

FIG. 4 is a diagram showing an illustrative timeline (400) of data placement within a cache system using a counter. The timeline (400) illustrates four primary sets (416), each of these sets being assigned to one secondary set (418). The timeline illustrates the status of these sets over seven time periods (402-414). The timeline also illustrates the counter value (420) for each of these time periods.

At time period 402, the processor requests data ABC. At this point, the cache is empty. Therefore, the system must retrieve ABC from main memory. As mentioned above, this type of event is referred to as a miss. In addition to retrieving ABC from main memory, the system places ABC into the primary cache. ABC is placed into the set associated with the location of ABC in main memory. In this case, that set is the primary set 0.

At time period 404, the system requests the data DEF. DEF is located at a location in main memory which maps to primary set 2. Because primary set 2 is currently empty, the system experiences a miss. Therefore, the system must retrieve DEF from main memory. In addition, the system places DEF into primary set 2 of the primary cache.

At time period 406, the system requests the data GHI. GHI is in a location in main memory that also maps to primary set 0. Therefore, GHI will be placed in primary set 0, evicting ABC. Upon eviction, the system will determine if ABC can be placed into the secondary set (418). At this point, the counter (422) for the corresponding portion of the secondary cache is at zero. Therefore, the secondary set (418) is available and ABC is placed therein.

At time period 408, the system again requests data ABC. The system first checks to see if ABC is in the primary cache. After determining that ABC is not in the primary cache, the system will then determine if ABC is located in the secondary cache. Because ABC is indeed in the secondary cache, the system experiences a hit in the secondary cache. This causes the counter (422) to increment to the value 1.

At time period 410, the system requests data JKL. JKL is currently located in a main memory location that maps to primary set 2. Thus, JKL will be placed in primary set 2 and the data DEF will be evicted. Upon eviction, the system will then determine whether or not DEF can be placed into the secondary set (418). The system checks the counter (422) and determines that the counter value is currently non-zero. Thus, DEF will not replace the current data within the secondary set (418).

At time period 412, the system requests the data MNO from main memory. MNO also maps to primary set 2. Therefore, MNO is placed into primary set 2 and data JKL is evicted. Because the counter is now at zero, JKL will replace ABC in the secondary set (418). At time period 414, the system requests the data JKL. This results in a hit to the secondary cache and the counter is then incremented.

The counter being a non-zero value indicates that the data currently within the secondary set (418) has been used by the system and is therefore likely to be used again. Thus, it is likely that the system will achieve better performance by leaving that value there instead of replacing it. However, the fact that another piece of data has attempted to use that spot indicates that other primary sets might make use of that secondary set. Consequently, the counter is decremented back to zero. This will leave the secondary set (418) open to data evicted from any of the primary sets (416) that map to that secondary set (418).

In general, a higher counter value indicates that the data within the associated secondary set is accessed often by the system. In this case, it is better for system performance that data is left there instead of replacing it with other blocks of data that may attempt to use that spot in the secondary cache. If a program is no longer causing the system to regularly access a highly accessed block of data, then, eventually, the counter will go back down to zero. This is because the counter is decremented each time other blocks of data attempt to replace the block of data currently within the secondary set (418).

In some cases, a counter may reach its highest value possible. For example, a four bit counter may take on 16 different values ranging from 0-15. If the counter reaches the value of 15, then it can no longer be incremented. In this case, a hit to the cache may not increment the counter. Rather, the counter will stay at that maximum level until it is caused to be decremented by an attempt to write different data to the secondary set associated with that counter.

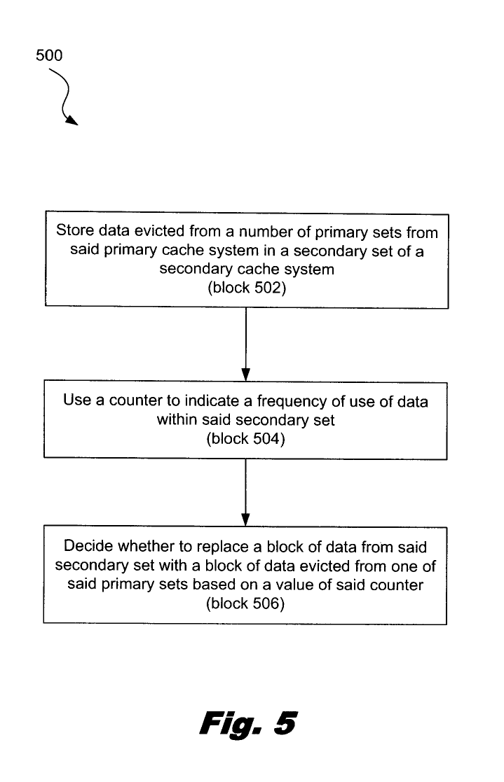

FIG. 5 is a flowchart showing an illustrative method for managing data evicted from a primary cache system. According to certain illustrative embodiments, the method includes storing (block 502) data evicted from a number of primary sets from the primary cache system in a secondary set of a secondary cache system. The method also includes using (block 504) a counter to indicate a frequency of access of data within the secondary set, and deciding (block 506) whether to replace a block of data from the secondary set with a block of data evicted from one of the primary sets based on a value of the counter.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A selective cache comprising:
a set designated to selectively receive data that has been evicted from any of a number of primary sets within a primary cache;
a counter configured to indicate a frequency of access to data within said set;
wherein a decision whether to replace data in said set with data from one of said primary sets is based on a value of said counter.

2. The selective cache of claim 1, wherein said counter is configured to:
increment in response to a hit to said set; and
decrement in response to eviction of said data from said one of said primary sets when said counter has a non-zero value.

3. The selective cache of claim 2, wherein said data within said set is replaced with said data from one of said primary sets if said counter is at zero.

4. The selective cache of claim 1, wherein said selective cache comprises a direct mapped cache.

5. The selective cache of claim 1, wherein said selective cache comprises an associative cache.

6. The selective cache of claim 1, wherein said selective cache is configured to swap data in said set with data from one of said number of sets of said primary cache in response to a hit to said set.

7. The selective cache of claim 1, wherein said selective cache comprises a victim cache and said primary cache system comprises a processor cache.

8. The selective cache of claim 1, wherein said selective cache comprises a Level 2 (L2) cache and said primary cache system comprises a Level 1 (L1) cache.

9. A cache system comprising:
a primary cache comprising a plurality of primary sets; and
a secondary cache comprising:
a number of secondary sets, each of said secondary sets configured to:
receive data evicted from any of a number of said primary sets;
increment a counter associated with that set in response to a hit to that set;
decrement said counter in response to eviction of data from one of said number of said primary sets when said counter has a non-zero value; and
replace data within said secondary set with said data from said number of said primary sets if said counter is at zero.

10. The system of claim 9, wherein said counter comprises one of: one bit, two bits and four bits.

11. The system of claim 9, wherein said secondary cache comprises a direct mapped cache.

12. The system of claim 9, wherein said secondary cache comprises an associative cache.

13. The system of claim 9, wherein said selective cache is configured to swap data in one of said secondary sets with data from one of said number of said primary sets in response to a hit to that secondary set.

14. The system of claim 9, wherein said secondary cache comprises a victim cache and said primary cache comprises a processor cache.

15. The system of claim 9, wherein said secondary cache comprises a Level 2 (L2) cache and said primary cache comprises a Level 1 (L1) cache.

16. A method for managing data evicted from a primary cache system, the method comprising:
storing data evicted from a number of primary sets of said primary cache system in a secondary set of a secondary cache system;
using a counter to indicate a frequency of access to data within said secondary set; and
deciding whether to replace data in said secondary set with data evicted from one of said primary sets based on a value of said counter.

17. The method of claim 16, wherein using said counter comprises:
incrementing said counter in response to a hit to said secondary set; and
decrementing said counter in response to eviction of said data from said one of said primary sets when said counter has a non-zero value.

18. The method of claim 17, further comprising replacing said data within said secondary set with said data from one of said primary sets if said counter is at zero.

19. The method of claim 16, wherein said selective cache comprises one of: a direct mapped cache and an associative cache.

20. The method of claim 16, further comprising swapping data in said secondary set with data from one of said number of sets of said primary cache in response to a hit to said set.

21. The method of claim 16, wherein said selective cache comprises a victim cache and said primary cache system comprises a processor cache.

22. The method of claim 16, wherein said cache system comprises a Level 2 (L2) cache and said primary cache system comprises a Level 1 (L1) cache.

23. The method of claim 16, wherein said counter comprise one of: one bit, two bits, and four bits.

24. A method for managing data evicted from a primary cache system, the method comprising:
storing data evicted from one of a number of primary sets of said primary cache system in a secondary set of a secondary cache system;
incrementing said counter in response to a hit to said secondary set; and
decrementing said counter in response to eviction of said data from one of said primary sets when said counter has a non-zero value; and
replacing said data within said secondary set with said data from one of said primary sets if said counter is at zero.

25. The method of claim 24, further comprising swapping data in said secondary set with data from one of said number of sets of said primary cache in response to a hit to said set.
